(19) United States
(12) Patent Application Publication
(10) Pub. No.: US 2006/0172251 A1
(43) Pub. Date: Aug. 3, 2006

(54) Orthopedic implant for mandibular advancer

(75) Inventor: John C. Voudouris, Toronto (CA)

Correspondence Address: MICHAEL BEST & FRIEDRICH, LLP, 100 E WISCONSIN AVENUE, MILWAUKEE, WI, 53202, US

(73) Assignee: OrthoArm, Inc., Toronto (CA)

(21) Appl. No.: 11/346,550

(22) Filed: Feb. 2, 2006

Related U.S. Application Data
(60) Provisional application No. 60/649,186, filed on Feb. 2, 2005.

(51) Int. Cl. A61C 3/00

(52) U.S. Cl. 433/18; 433/19

(57) ABSTRACT

A mandibular advancer assembly comprising an advancer (e.g., a spring advancer, such as a Herbst appliance) having an upper end and a lower end, and a lower implant secured to the lower end of the advancer and adapted to be secured to the mandible of the patient. Preferably, the lower implant comprises a bone-engaging member (e.g., a bone screw) and a securing member for coupling the lower end of the advancer to the bone-engaging member. For example, the bone-engaging member can include a threaded orifice, and the securing member can include a threaded element engaged with the threaded orifice. If desired, the advancer assembly can further include an upper implant secured to the upper end of the advancer and adapted to be secured to the maxilla of the patient.

### FIELD OF THE INVENTION

This invention relates to the field of orthodontics, and more particularly to mandibular advancers.

### BACKGROUND OF THE INVENTION

The use of orthodontic mandibular advancer appliances to treat people with a small lower jaw (mandible) or receding chin is known. This horizontal projection of upper teeth beyond the lower teeth is also referred to as overjet. There are essentially two known types of lower jaw advancers: rigid Herbst advancers and spring advancers.

Variations of the rigid Herbst advancer, often referred to as a Herbst appliance, include banded, stainless steel crown coverage, and cast-splint versions. All Herbst appliances rigidly hold the lower jaw forward and do not let it set back into the jaw joint socket (fossa). This can lead to condylar (lower jaw joint bone) resorption.

There are several types of mandibular spring advancers, which are generally preferred over Herbst appliances due to the ability of the lower jaw to relax somewhat back into the fossa, preventing condylar resorption. A few types of known spring advancers are described below.

U.S. Pat. No. 5,711,667 discloses an appliance consisting of a telescoping plunger, a metal cylinder for receiving the plunger, and a spring attached between the cylinder and the plunger that causes the application of a relatively constant pushing force. The appliance is provided at each end with connectors that interact with orthodontic braces.

U.S. Pat. No. 5,964,588 discloses an appliance consisting of three members, with the second member sliding in the first member and the third member sliding in the second. The appliance includes a spring extending around the second member for urging the first and second members in opposite directions. At each end, the appliance includes a connector for attaching to an orthodontic element.

U.S. Pat. No. 4,708,646 discloses a flexible member, which may comprise a covered coiled wire, attached to orthodontic elements on the upper and lower jaws of a patient. On the lower jaw, the appliance may be attached either to a U-shaped wire extension having a ball stop, or directly to the lower arch wire. On the upper jaw, the appliance may be attached to a small ball fixed to an adjustable rear wire that is retained within the molar tube attached to the patient's upper jaw teeth. In the absence of orthodontic braces, rigid plastic cover inserts having anchoring means are provided for both the upper and lower jaws.

The “Twin Force Bite Corrector,” made by Ortho Organizers, Inc., consists of joint telescopic systems containing internal coil springs. The appliance is attached to the upper back first molars through a ball pin that is fitted into the buccal tube of a molar band, and to the lower arch wire in the lower cuspid area.

Each jaw consists of both a skeletal component and a dental component (tooth sockets), and the existing Herbst and spring advancers use the entire upper and lower dental components as anchorage units by attaching the appliance to orthodontic elements. By forcing the mandible forward with a compressed spring or fixed Herbst advancer, the lower dentition is pushed forward, sometimes off the base of the bone, resulting in unfavorable side-effects such as gum recession and root exposure.

### SUMMARY OF THE INVENTION

The present invention provides a single or multi-piece orthopedic implant for anchoring mandibular advancer appliances. More particularly, the invention provides an orthopedic implant that is placed directly into the skeletal component of at least the lower jaw, thus creating an immutable and stable anchorage unit. Anchoring a Herbst appliance or spring advancer using the implant provided by the present invention applies a force to the skeletal component itself, rather than the dental component of the lower jaw, alleviating the above-described and other problems with existing Herbst appliances and spring advancers.

The orthopedic implant provided by the present invention may also be placed in the skeletal component of the upper jaw (maxilla). Orthopedic force to the implant when placed in the skeletal component of the upper jaw restricts natural forward growth of the upper jaw, assisting overjet correction.

In another construction, the maxillary anchorage may be placed directly on orthodontic elements, or directly on the dental component of the upper jaw, rather than in the skeletal component. This construction of the invention can facilitate moving the upper teeth backward, in addition to restricting forward growth of the upper jaw, further assisting overjet correction.

### BRIEF DESCRIPTION OF THE DRAWINGS

FIG. 1 is a perspective view of an upper and lower jaw with a mandibular advancer appliance anchored by orthopedic implants embodying the present invention.

FIG. 2 is a perspective view of the mandibular advancer appliance of FIG. 1 removed from the upper and lower jaw for purposes of illustration.

FIG. 3 is an exploded view of one end of the mandibular advancer appliance of FIG. 1.

FIG. 4 is a section view, through line 4-4 of FIG. 2.

FIG. 5 is an exploded view of an alternative embodiment of the invention illustrating attachment of the orthopedic implant to a mandibular advancer appliance.

FIG. 6 is a perspective view of an upper and lower jaw with a mandibular advancer appliance anchored on the lower jaw by the orthopedic implant of FIG. 1 and on the upper jaw by attachment to an orthodontic element.

Before embodiments of the invention are explained in detail, it is to be understood that the invention is not limited in its application to the details of construction and the arrangements of the components set forth in the following description or illustrated in the drawings. The invention is capable of other embodiments and of being practiced or being carried out in various ways. Also, it is to be understood that the phraseology and terminology used herein is for the purpose of description and should not be regarded as limiting. The use of “having,” “including,” and “comprising” and variations thereof is meant to encompass the items listed thereafter and equivalents thereof as well as additional items.

### DETAILED DESCRIPTION

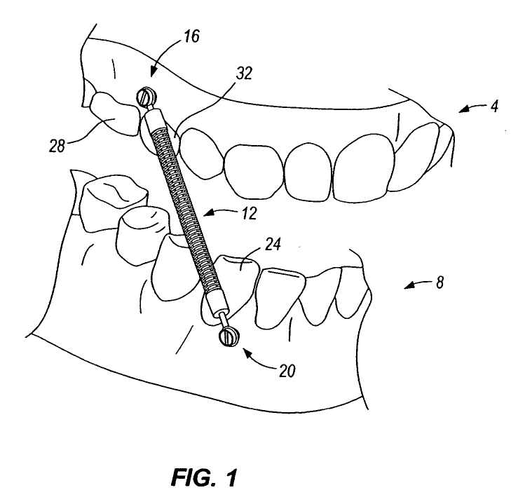

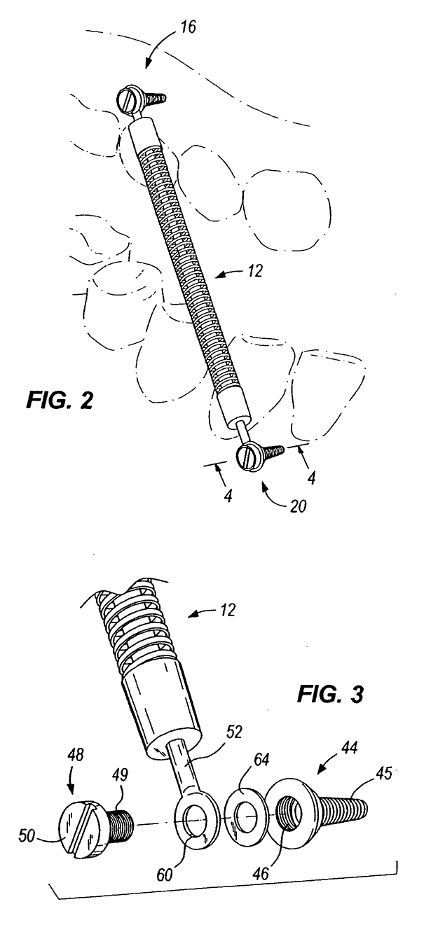

FIG. 1 illustrates an upper jaw 4, a lower jaw 8, and a mandibular advancer appliance 12 in an operating position. The mandibular advancer appliance 12 is anchored by upper and lower orthopedic implants 16, 20 embodying one construction of the invention. The lower implant 20 is shown embedded in the skeletal component of the lower jaw 8 in approximately the region of the mesial (forward) aspect of the mandibular canine 24. The upper implant 16 is shown embedded in the skeletal component of the upper jaw 4 between the maxillary first molar 28 and the maxillary second premolar 32.

FIG. 3 illustrates the lower implant 20 in greater detail. In the construction shown in FIG. 3, the multi-piece implant 20 includes a bone screw component 44, having both a male-threaded portion 45 and a female-threaded portion 46, and a securing screw component 48 including a male-threaded portion 49 and a head portion 50. The bone screw component 44 and securing screw component 48 may be constructed of any suitable material, such as stainless steels, alloy metals, ceramics, plastics, or composites comprised of combinations of different materials. The male-threaded portion 49 of the securing screw component 48 is designed to be threaded into the female-threaded portion 46 of the bone screw component 44.

The mandibular advancer appliance 12 shown in FIG. 3 includes a connecting member 52 having an aperture 60 of appropriate size such that the male-threaded portion 49 of the securing screw component 48 is able to pass through the aperture 60, but the non-threaded head portion 50 of the securing screw component 48 is not able to pass through the aperture 60. In this construction, the appliance 12 is anchored by inserting the male-threaded portion 49 of the securing screw component 48 through the aperture 60 in the connecting member 52 and threading the securing screw component 48 in the bone screw component 44, thereby clamping a portion of the connecting member 52 between the securing screw component 48 and the bone screw component 44. In this construction, a washer 64 is also placed between the clamped portion of the connecting member 52 and the bone screw component 44.

In practice, each implant 20 to be used in treatment would typically first be put in the condition of a multi-piece assembly, with the securing screw component 48 threaded in the bone screw component 44. Following dental anesthesia, the implants 20, as assemblies, would be screwed into the skeletal component of the jaw 4,8 in the desired locations. Following approximately two to six months of healing, the securing screw component 48 would be unscrewed from the bone screw component 44, and a mandibular advancer appliance 12 would be attached to each implant 20, thereby initiating treatment. Generally, following approximately 1.0 to 1.5 years of orthopedic treatment, the implants 20 would be removed from the jaw 4,8.

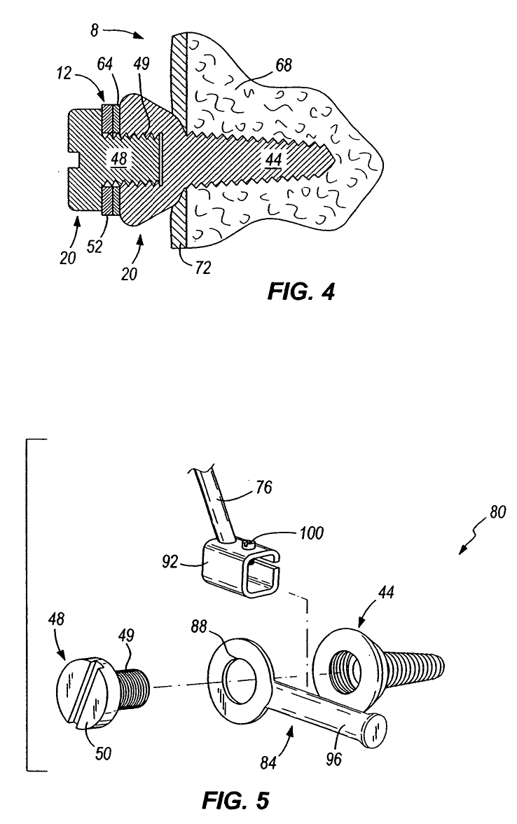

FIG. 4 shows the implant 20 embedded in the skeletal component 68 of a jaw 8 and anchoring a mandibular advancer appliance 12. As shown, the bone screw component 44 of the implant is embedded in the skeletal component 68 of the jaw 8, and the securing screw component 48 of the implant is threaded in the bone screw component 44. The washer 64 and a portion of the connecting member 52 are shown circumscribing the male-threaded portion 49 of the securing screw component 48 and clamped between the securing screw component 48 and the bone screw component 44. As shown in FIG. 4, the implant 20 protrudes off of the gum tissue 72 far enough to avoid rotational impingement of the connecting member 52 on the gum tissue 72.

FIG. 5 illustrates an alternative embodiment of the invention and shows one way the alternative embodiment may attach to a mandibular advancer appliance 76. In this construction of the invention, an extension component 84 is added as a third piece of the implant 80, along with the securing screw component 48 and the bone screw component 44. The extension component 84 may be constructed of any suitable material, such as stainless steels, alloy metals, ceramics, plastics, or composites comprised of combinations of different materials. The extension component 84 includes an aperture 88 of appropriate size such that the male-threaded portion 49 of the securing screw component 48 is able to pass through the aperture 88, but the non-threaded head portion 50 of the securing screw component 48 is not able to pass through the aperture 88. In this construction, the extension component 84 is secured in place by inserting the male-threaded portion 49 of the securing screw component 48 through the aperture 88 in the extension component 84 and threadably securing the securing screw component 48 in the bone screw component 44, thereby clamping a portion of the extension component 84 between the securing screw component 48 and the bone screw component 44.

In the construction shown in FIG. 5, the mandibular advancer appliance 76 includes an attachment member 92 having a generally C-shaped cross-section. The attachment member 92 can be affixed to the extension component 84 by sliding the attachment member 92 onto the shaft portion 96 of the extension component 84 and tightening a locking fastener 100 to secure the attachment member 92 in a desired location along the shaft portion 96 of the extension component 84. The locking fastener 100 may be a set screw or any other fastening mechanism capable of securing the attachment member 92 in place.

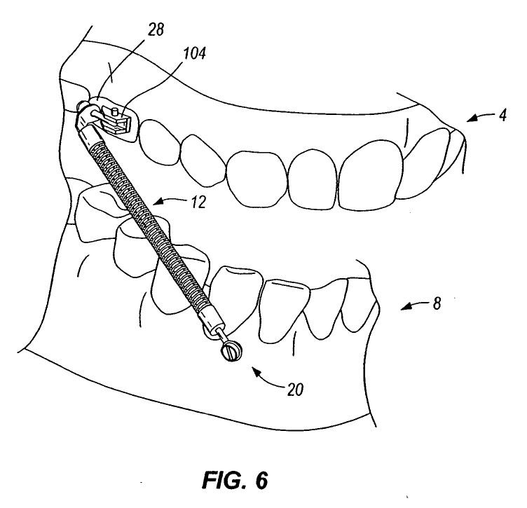

In FIG. 6, the mandibular advancer appliance 12 is anchored on the lower jaw 8 by the lower implant 20, and on the upper jaw 4 by attachment to an orthodontic element 104. As shown in FIG. 6, the appliance 12 is attached to an orthodontic element 104 on the maxillary first molar 28. The appliance 12 may also be attached to other orthodontic elements or directly to the dental component of the upper jaw.

In all of the figures and embodiments illustrated, the mandibular advancer appliances 12, 76 may be a rigid Herbst appliance, a spring advancer, or any other device useful for mandibular advancement. In addition, it is important to note that the mandibular advancer appliances may be attached to the orthopedic implants in many ways, and that the methods of attachment are not limited to the constructions described above.

What is claimed is:

1. A mandibular advancer assembly comprising:
an advancer having an upper end and a lower end; and
a lower implant secured to the lower end of the advancer and adapted to be secured to the mandible of the patient.

2. The mandibular advancer assembly of claim 1, where the advancer comprises a spring advancer.

3. The mandibular advancer assembly of claim 1, wherein the advancer comprises a Herbst appliance.

4. The mandibular advancer assembly of claim 1, wherein the lower implant comprises a bone-engaging member.

5. The mandibular advancer assembly of claim 4, wherein the bone-engaging member comprises a bone screw

6. The mandibular advancer assembly of claim 4, wherein the lower implant further comprises a securing member for coupling the lower end of the advancer to the bone-engaging member.

7. The mandibular advancer assembly of claim 6, wherein the bone-engaging member comprises a threaded orifice, and wherein the securing member comprises a threaded element engaged with the threaded orifice.

8. The mandibular advancer assembly of claim 7, wherein the lower end of the advancer is between the securing member and the bone-engaging member.

9. The mandibular advancer assembly of claim 1, further comprising an upper implant secured to the upper end of the advancer and adapted to be secured to the maxilla of the patient.

10. A method of installing in a patient a mandibular advancer having a lower end and an upper end, the patient having a mandible and a maxilla, and the method comprising:
securing a lower implant to the mandible of the patient;
attaching the lower end to the lower implant; and
coupling the upper end to the maxilla of the patient.

11. The method of claim 10, wherein securing includes screwing the lower implant into the mandible.

12. The method of claim 10, wherein attaching includes attaching a securing member to the lower implant.

13. The method of claim 12, wherein attaching includes screwing the securing member into the lower implant

14. The method of claim 12, wherein attaching includes positioning the lower end between the securing member and the lower implant.

15. The method of claim 10, wherein coupling includes:
securing an upper implant to the maxilla of the patient; and
attached the upper end to the upper implant.
